(19) United States
(12) Patent Application Publication
(10) Pub. No.: US 2026/0307912 A1
(43) Pub. Date: Oct. 8, 2026

(54) IMPACT ROLLER, TRANSPORT SYSTEM AND METHOD OF ASSEMBLING AN IMPACT ROLLER

(71) Applicant: RULLI RULMECA S.P.A., Alme', Bergamo (IT)

(72) Inventors: Simone COSTA, Amle', Bergamo (IT); Alessandro PASTA, Alme', Bergamo (IT)

(21) Appl. No.: 19/482,703

(22) PCT Filed: Feb. 23, 2024
(86) PCT No.: PCT/IB2024/051760

§ 371 Date: Nov. 7, 2025

(30) Foreign Application Priority Data
May 10, 2023 (IT) 102023000009336

(51) Int. Cl. B65G 39/06; B65G 39/09

(52) U.S. Cl. CPC B65G 39/06; B65G 39/09; B65G 2207/48

(57) ABSTRACT

An impact roller includes a tubular support element with an outer tubular element skirt. The tubular support element supports an elastic coating with at least one elastic plug having an inner tubular elastic plug surface which, when the elastic plug is disassembled, has a smaller inner diameter than the predefined support surface diameter. The elastic coating includes at least one reinforced plug having a reinforced plug base which is associated with a reinforcing ring. The reinforced plug includes an inner tubular reinforced plug surface which, when the reinforced plug is disassembled, has a smaller inner diameter than the predefined support surface diameter and a greater inner diameter than the elastic plug inner diameter.

### CROSS-REFERENCE TO RELATED APPLICATIONS

This application is a National Stage Application of PCT/IB2024/051760, filed Feb. 23, 2024, which claims benefit of priority to IT Patent Application No. 102023000009336 filed on May 10, 2023, and which applications are incorporated herein by reference. To the extent appropriate, a claim of priority is made to each of the above disclosed applications.

### TECHNICAL FIELD OF THE INVENTION

The invention belongs to the general technical field of impact rollers for conveyor belts.

More specifically, the invention relates to the technical field of impact rollers for a conveyor belt which can absorb a large amount of blows, is structurally robust and has an improved duration. The present invention relates to an impact roller for a conveyor belt capable of improving resistance to deformation against a load and, in particular, capable of improving the reliability of the plugs capable of dampening the blow undergone by the object transported or falling material.

### BACKGROUND ART

In conveyor belts, there are usually different areas according to the specific function that the area needs to accomplish for transporting material.

Mainly, there can be an “impact area”, where the material, from other conveyor belts and/or unloading systems, is loaded onto a belt, or conveyor belt, passing first through a hopper or by means of screening systems. The area is referred to as an “impact” area due to the impact that is created between the conveyor belt support rollers in this area and the falling material, which can have a different particle size and fall from different heights. This area generally has a reduced length.

In addition, there is a “transport area”. In this area, which tends to be the longest area of the conveyor belt, the material is transported also for long distances. In this area, there are no forces external to the conveyor belt, other than those of the weight of the material transported, belt tensions and forces due to vertical and horizontal curves.

In addition, there is a “transition area”. In this area, the conveyor belt switches from a flat position (dictated by the presence of a winding drum) to a dipped position by means of some sets of varying-angle structures. This area generally has a reduced length.

Lastly, there is a “return area”. This is the return branch of the conveyor belt, where a series of flat or V-inclined stations support the (unloading) belt up to the tail drum, ending the course of the conveyor belt and again bringing it to the material loading area, in the impact area.

In order to limit the effect of the impact of the material on the rollers themselves, the support and/or guiding rollers of the conveyor belt in the “impact area” are usually covered by a series of rings, or plugs, made of rubber of adequate thickness and resistance.

Therefore, the impact rollers are stressed not only due to the loading of the material, but also due to the dynamic forces caused on the rollers as the load falls onto the conveyor belt, such as depicted in FIG. 1, for example.

Rollers are known where, in order to limit the effect of the impact caused by the blow of material transported, for example, caused by the material falling onto the conveyor belt supported by the roller, the outer skirt of the roller is directly covered by synthetic or rubber material, material which is directly vulcanized onto the surface of the roller. Although they are satisfactory from many viewpoints, these known solutions are very complex to create and therefore very costly, also due to the need to replace the entire roller in the case of breakdown or wear of the covered skirt.

Document KR100592483 “Impact Roller for Conveyor” discloses an impact roller adapted to roll while it absorbs the impact. This solution has a tubular support element freely rotatable on a fixed shaft supported by a structure. The rotatable tubular element has a plurality of rubber rings fitted onto the skirt thereof. An assembly hollow is also on both ends of the skirt, where there is inserted a stop ring which blocks a metal retaining wedge adapted to prevent the rubber rings from slipping off and to bundle them due to the inverse taper on the side facing the stop ring.

Although satisfactory from certain viewpoints, this solution involves a solution of axial limitation of the movement of the ring bundle (here obtained with a metal wedge and a stop ring which acts as a spring coupled to a hollow obtained on the rotatable tubular element) and of the “mechanical abutment” type, which solution requires an accurate machining of the skirt of the rotatable tubular element, which machining increases the probability of assembly errors, complicates the assembly by requiring an accurate position of the ring bundle and an accurate construction tolerance thereof, as well as creates a discontinuous surface, almost a blade on the skirt of the rotatable tubular element, which often ruins the inner surface of the rubber rings when they are fitted onto the skirt.

Another solution of this type is known from CN202181088U.

Document KR20090075966 “Impact Roller for Conveyor” discloses an impact roller for a conveyor belt developed to prevent the wedging of foreign material between the elastic rings absorbing and damping the blow. This solution includes an impact roller for a conveyor belt comprising a shaft, a tube of the roller which is keyed onto the shaft by means of a bearing, and a support and damping impact-absorbing element fitted onto the tube of the roller. The support and damping element comprises an inner cylindrical ring, an outer cylindrical ring and a damper which absorbs the impact, interposed between the inner ring and the outer ring. The pleated shape of the damper allows the outer cylindrical ring of each element to be positioned abutting against the outer ring of the adjacent element, thus preventing the insertion of foreign objects between the elements.

It is the object of this solution to avoid the axial deformation of the inner and outer rings (which can be indistinctly reinforced with a reinforcing element) and concentrate the deformation on the intermediate damper.

This solution, which is satisfactory from different viewpoints, is however very complex to build and maintain, requiring elastic rings with a very complex geometry to be produced which requires the use of processes with complex molds provided with various undercuts.

In addition, this solution requires very complex assembly processes since the inner ring of each elastic ring is built to limit the radial deformation thereof, making the process of fitting each individual ring onto the tube of the roller very complex. Thus, the production and assembly process of this solution is also laborious and costly.

Other solutions of this type are known from KR100782604.

### SUMMARY OF THE INVENTION

Therefore, it is the object of the present invention to solve the drawbacks of the prior art and allow having an impact roller which is very efficient in its ability to absorb blows, while being simplified to make, assemble and maintain.

By virtue of the general embodiment and variants described above and further described below, it is possible to obtain the following advantages.

The innovative solution to suggest takes advantage of the “seal effect” and allows the plug bundle to remain in place without machining the outer tubular element skirt of the tubular support element, taking advantage of the high pressure which is formed between the reinforced plug foot and the tubular support element.

The existing difference between the impact rollers of the prior art and those of the present invention is fundamentally, in particular, how the bundle of elastic plugs is kept in place.

Specifically.

Using an elastic plug without a metal core/reinforcing ring, a metal stop is required to keep the bundle of elastic plugs in place. This is because the pressure generated following the interference between the outer diameter of the tubular support element and the inner diameter of the elastic plug (normally of the order of 5-8 mm) is lost in the deformation of the rubber of the elastic plug, which changes sizes and diameters.

The deformation generated does not allow the bundle of elastic plugs to remain in place during the life cycle of the product, with increased impacts and stress.

Differently, with the suggested solution which uses a reinforcing plug and a reinforcing ring, it is these reinforced plugs outside the bundle of elastic plugs to provide the seal of the plug bundle on the tubular support element.

This is because the pressure generated following the interference between the outer diameter of the tubular support element and the inner diameter of the reinforced plug is transformed into an increase in localized pressure between the reinforcing ring and the outer tubular element skirt.

This pressure deforms the elastic material in this space (reinforced plug foot), greatly increasing the specific contact pressure between these two components, creating a preloading sealing effect in this area of elastic material which is never unloaded, cancelling the interference and creating a play which would move the reinforced plug from its position. However, at the same time, the outer part of the reinforcing ring remains deformable and capable of damping a blow and, above all, without modifying the blow absorption and damping performance of the affordable elastic plugs.

This ensures the seal of the bundle of elastic plugs for the entire life cycle of the produced impact roller herein claimed.

Due to the provision of at least one reinforcing plug which, due to the geometry thereof, is firmly connected to the tubular support element blocking the at least one elastic plug and avoiding the need to machine the outer tubular element skirt which remains perfectly cylindrical and smooth, thus facilitating the process of fitting the plugs, not only it is possible to have a simplified and quicker construction and assembly process, but it is possible to have an even further simplified assembly process due to the reduction of the processing steps.

Indeed, while in a process of assembly a conventional roller with elastic plugs blocked in a bundle by means of a stop received in a seat of the outer tubular element skirt, the roller necessarily is first fitted with the elastic plugs and then moved into the welding station of the stop element and then painting station, stations which often are far from them, if not outside the assembly area, in this solution, albeit using elastic plugs, known per se and affordable, due to the suggested solution, it is possible to completely avoid the mechanical machining prior to the process of fitting the plugs, thus avoiding the welding of the stop elements, which are no longer used here, and include painting as the step prior to fitting the plugs onto the tubular support element.

Therefore, with respect to the process of the prior art, the impact roller here suggested does not need any subsequent welding process because the elastic plugs being held in place during the normal use is ensured by the outer reinforced plugs.

From a production viewpoint, this provides a great competitive advantage:
1. in the case of painted rollers, the management of this machining can be rationalized in the steps prior to the assembly, resulting in a strong advantage on the economies of scale in production. For all of above, the roller can be pre-painted prior to the assembly of the plugs;
2. in addition, the quality of the product will be increased: instead of limiting the painting to the ends (generally liquid paint), with this solution, the resistance to corrosion of the roller can be increased with a powder paint of the entire outer tubular element skirt;
3. in addition, the production spaces are optimized: logistically, the assembled product will no longer require moving between different departments, rather the flow will be linear. After the plugs are pressed to fit them onto the tubular support element, the finished impact roller is ready for delivery to the customer.

### BRIEF DESCRIPTION OF THE DRAWINGS

Further features and advantages of the invention will become apparent from the description provided below of preferred embodiments thereof, given by way of non-limiting indication, with reference to the accompanying drawings, in which:

FIG. 1 shows a diagrammatic side view of a first unloading end section of a first conveyor belt, for example, for transporting crushed stone, herein generally referred to as a falling material, which unloads crushed stone into a hopper in the impact area of a second conveyor belt, supported by impact rollers;

FIG. 2 shows an axonometric view of an impact roller which shows a middle bundle of elastic plugs and two opposite reinforced plugs at the opposite ends of the bundle of elastic plugs;

FIG. 3 shows an axonometric view with separate parts of the impact roller in FIG. 2;

FIG. 4 shows a sectional view along an axial-radial plane of the roller in FIG. 2;

FIG. 5 shows a sectional view according to an axial-radial plane of an impact roller according to a further embodiment;

FIG. 6 shows an axial view of an impact roller without the elastic plugs and the reinforcing plugs adjacent to which there is an assembly tool;

FIG. 7 shows a sectional view according to an axial-radial plane of an assembly step of an impact roller, here shown without elastic plugs and reinforced plugs, adjacent to which there is the assembly tool;

FIG. 8 shows a sectional view according to an axial-radial plane of a further assembly step, in which a reinforced plug is fitted onto the assembly tool;

FIG. 9 shows a sectional view according to an axial-radial plane of a further assembly step, in which the reinforced plug in FIG. 8 is pushed with a press, indicated in the drawing by reference numeral 40, along the assembly tool up to deforming it within the dimension of the outer tubular element skirt;

FIG. 10 shows a sectional view according to an axial-radial plane of a further assembly step, in which the reinforced plug in FIG. 8 is pushed with a press along the outer tubular element skirt up to bringing it to the desired position;

FIG. 11 shows a sectional view according to an axial-radial plane of a further assembly step, in which a plurality of elastic plugs is fitted onto the assembly tool;

FIG. 12 shows a sectional view according to an axial-radial plane of a further assembly step, in which the plurality of elastic plugs in FIG. 11 is pushed with a press along the assembly tool up to deforming it within the dimension of the outer tubular element skirt, and therefore it is pushed with a press along the outer tubular element skirt up to bringing it to the desired position, here bundled with the reinforced plug already positioned;

FIG. 13 shows a sectional view according to an axial-radial plane of a further assembly step, in which the operations in FIGS. 11 and 12 are repeated up to loading the outer tubular element skirt with all the desired elastic plugs, and the operations in FIGS. 8, 9 and 10 are repeated for all the reinforced plugs to be fitted between the elastic plugs or at the end of the elastic plugs to block the bundle of elastic plugs;

FIG. 14 shows a sectional view according to an axial-radial plane of a further assembly step, in three assembly steps, an elastic plug being deformed as it is pushed along the assembly tool;

FIG. 15 shows a sectional view according to an axial-radial plane of a further assembly step, in three assembly steps, a reinforced plug being deformed as it is pushed along the assembly tool.

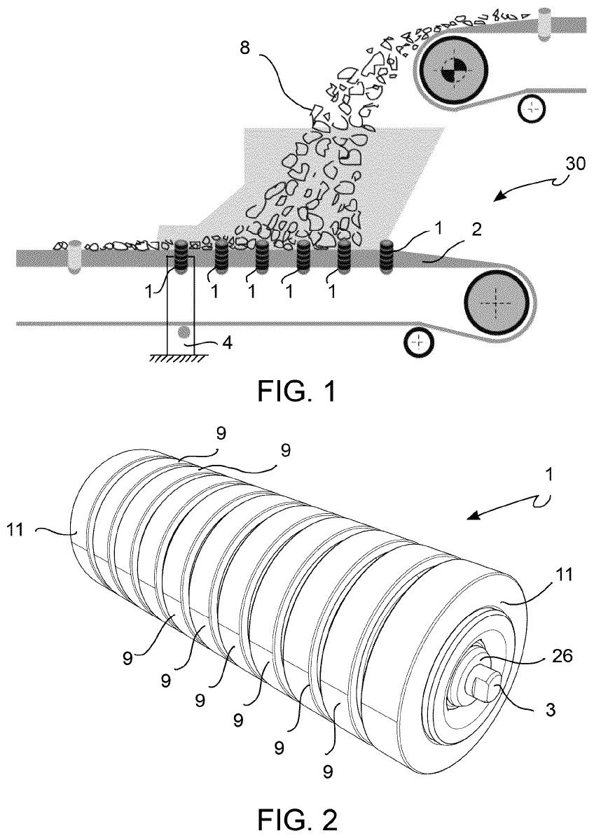

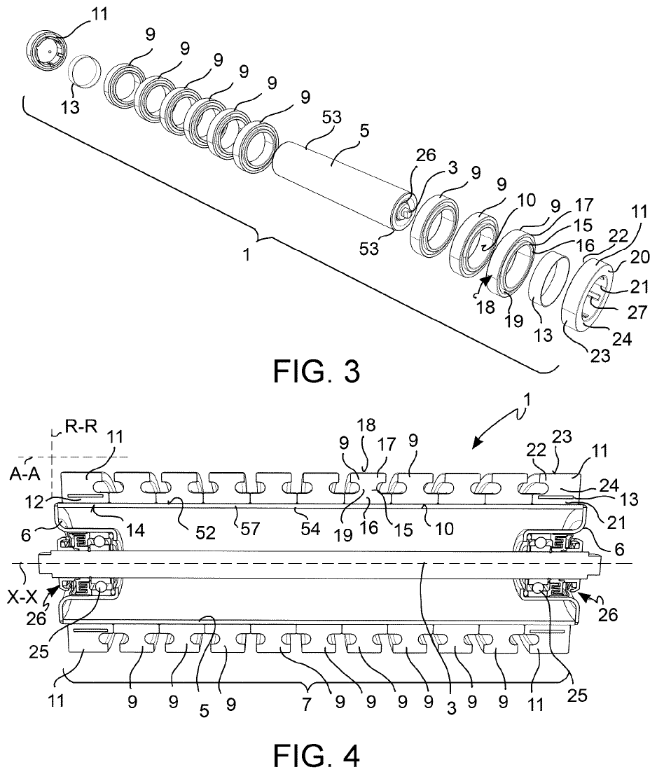

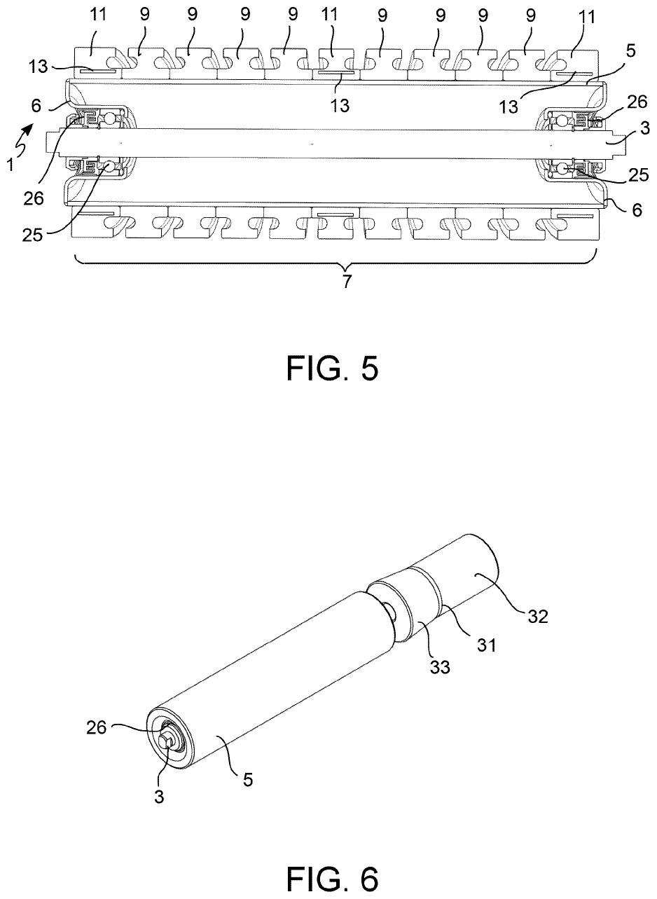

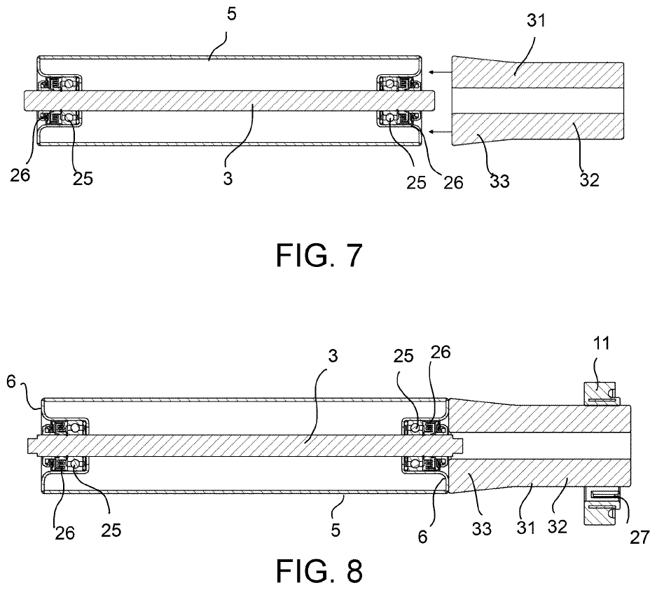

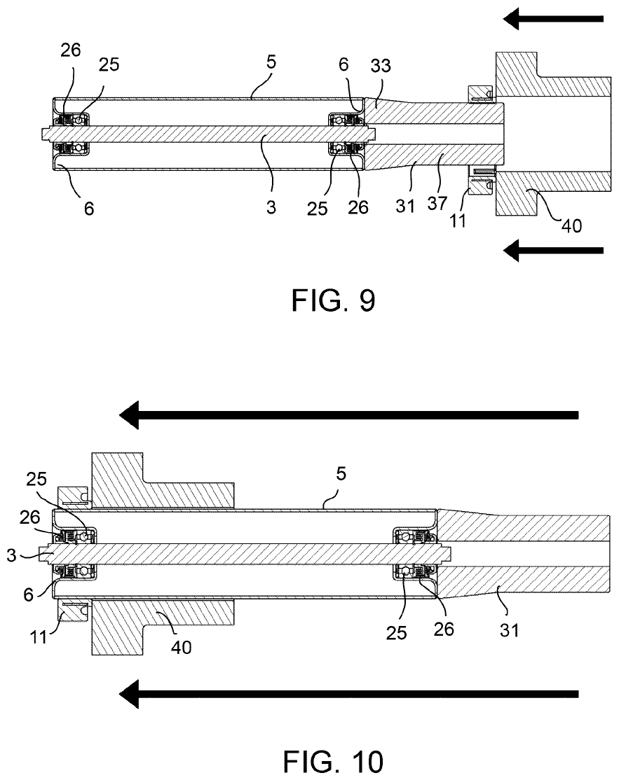

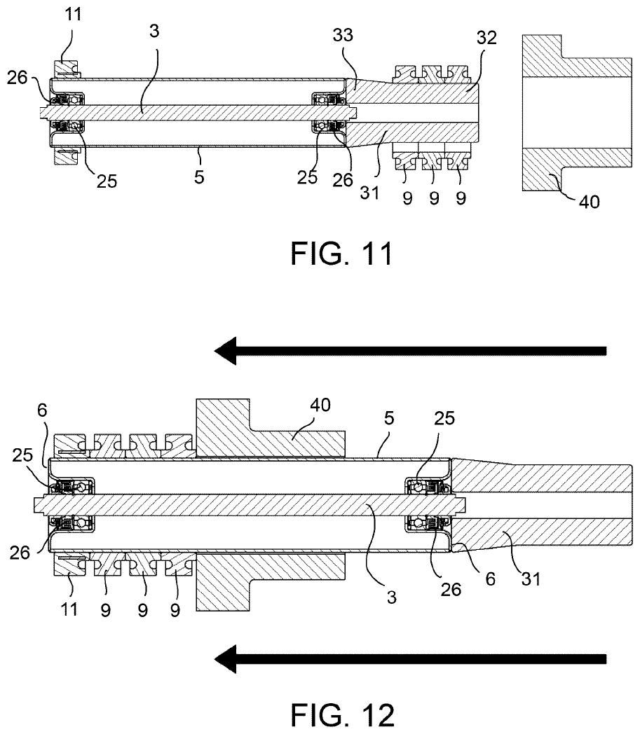

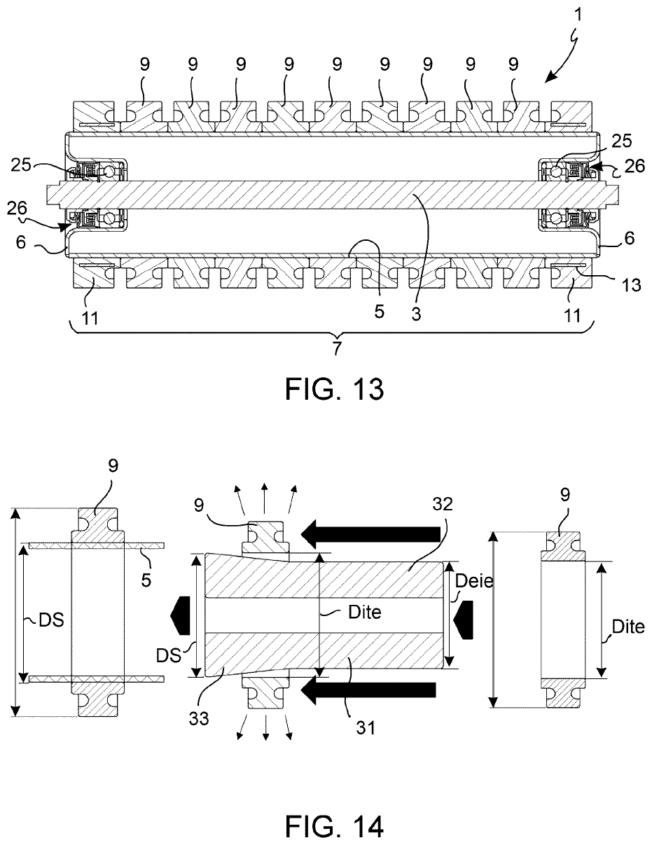

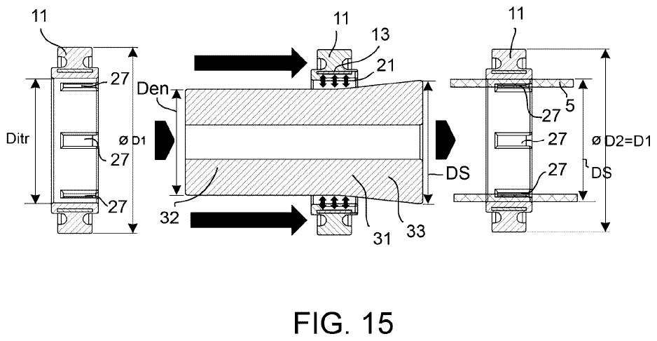

### DETAILED DESCRIPTION

The present invention will now be described in detail with reference to the accompanying drawings to allow those skilled in the art to make it and use it. Various changes to the embodiments described will be readily apparent to those skilled in the art and the general principles described can be applied to other embodiments and applications without departing from the scope of protection of the present invention, as defined in the appended claims. Therefore, the present invention should not be considered as limited to the embodiments described and shown, but should be granted the broadest scope of protection in compliance with the features described and claimed.

Unless otherwise defined, all the technical and scientific terms used herein have the same meaning commonly used by those of ordinary skill in the field to which the present invention pertains. In the case of a conflict, the present description, including the definitions provided, will be binding. Moreover, the examples are merely provided for illustrative purposes, and as such they should not be considered as limiting.

In order to facilitate the understanding of the embodiments described herein, reference will be made to some specific embodiments and a specific language will be used to describe them. The terminology used herein has the purpose of describing only particular embodiments, and is not intended to limit the scope of the present invention.

According to a general embodiment, an impact roller 1 for a conveyor belt 2 comprises a tubular support element 5 extending in an axial direction A-A and adapted to rotate about a rotation axis X-X; said tubular support element 5 comprises an outer tubular element skirt, or tubular skirt, with reference numeral 57, delimiting a tubular element support surface 52 having a predefined support surface diameter Ds. Said tubular support element 5 externally supports an elastic coating 7 adapted to receive impacts due to the fall of falling material 8 against said impact roller 1.

Said elastic coating 7 comprises at least one elastic plug 9 elastically deformable in at least a radial direction R-R orthogonal to said axial direction A-A.

Said elastic plug 9 comprising an inner tubular elastic plug surface 10.

Said elastic plug 9, with said inner tubular elastic plug surface 10, is fitted onto said tubular element support surface 52 of said tubular support element 5.

Said inner tubular elastic plug surface 10, when the elastic plug 9 is disassembled from said tubular support element 5 and under unworn resting conditions, has, in a radial section thereof, a smaller elastic plug inner diameter Dite than said predefined support surface diameter Ds.

Said elastic coating 7 comprises at least one reinforced plug 11 made of elastic material; where said reinforced plug 11 comprises a reinforced plug base 12.

Said reinforced plug base 12 comprises at least one annular reinforcing ring 13 made of a material other than the material of the reinforced plug 11; and where said reinforced plug 11 comprises an inner tubular reinforced plug surface 14.

Said reinforced plug 11, with said inner tubular reinforced plug surface 14, is fitted onto said tubular element support surface 52 of said tubular support element 5.

Said inner tubular reinforced plug surface 14, when the reinforced plug 11 is disassembled from said tubular support element 5 and under unworn resting conditions, has, in a radial section thereof, a smaller reinforced plug inner diameter Ditr than said predefined support surface diameter Ds and a greater reinforced plug inner diameter Ditr than said elastic plug inner diameter Dite.

According to an embodiment, said tubular support element 5 comprises at least one tubular skirt end 53.

Said reinforced plug 11 is placed close to said tubular skirt end 53.

According to an embodiment, said tubular support element 5 comprises two opposite tubular skirt ends 53.

A reinforced plug 11 is provided close to each of said opposite tubular skirt ends 53.

According to an embodiment, said tubular support element 5 comprises two opposite tubular skirt ends 53 and a central tubular skirt area 54 placed substantially equally spaced apart from said two opposite tubular skirt ends 53.

A reinforced plug 11 is provided close to each of said opposite tubular skirt ends 53.

At least one reinforced plug 11 is provided at said central tubular skirt area 54.

According to an embodiment, said elastic coating 7 comprises a plurality of elastic plugs 9 placed side-by-side.

Two opposite reinforced plugs 11 placed side-by-side are provided at the ends of said plurality of elastic plugs 9.

According to an embodiment, said elastic coating 7 comprises a plurality of adjacent elastic plugs 9 in contact two-by-two, i.e., bundled.

Two opposite reinforced plugs 11 keeping said plurality of elastic plugs 9 bundled are provided at the ends of said plurality of bundled elastic plugs 9.

According to an embodiment, said elastic coating 7 comprises a first plurality of elastic plugs 9 placed side-by-side; and where two opposite reinforced plugs 11 placed side-by-side are provided at the ends of said first plurality of elastic plugs 9. Said elastic coating 7 comprises a second plurality of elastic plugs 9 placed side-by-side; and where a first end of said second plurality of elastic plugs 9 placed side-by-side is placed in contact with one of the reinforced plugs 11 placed at the ends of said first plurality of elastic plugs 9; and where a further reinforced plug 11 is placed at the opposite end of said second plurality of elastic plugs 9.

According to an embodiment, said elastic plug 9 has an annular elastic plug body 15.

According to an embodiment, said elastic plug 9 has an annular, single-piece elastic plug body 15 made of elastic material.

According to an embodiment, said elastic plug 9 has an annular elastic plug body 15 without annular inserts made of different material.

According to an embodiment, said elastic plug 9 has an annular elastic plug body 15 without annular inserts made of different material so that when the elastic plug 9 is fitted onto said tubular support element 5, substantially all the material of said elastic plug body 15 is subject to circumferential stress.

According to an embodiment, said elastic plug 9 has an annular elastic plug body 15.

In cross section to the annular extension thereof, it has an elastic plug foot 16 in contact with said tubular support element 5; an elastic plug head 17 radially externally forming an outer impact surface 18; an elastic plug stem 19 placed radially between said elastic plug foot 16 and said elastic plug head 17.

According to an embodiment, said elastic plug 9 has an annular elastic plug body 15.

In cross section to the annular extension thereof, it has an elastic plug foot 16 in contact with said tubular support element 5; an elastic plug head 17 radially externally forming an outer impact surface 18; an elastic plug stem 19 placed radially between said elastic plug foot 16 and said elastic plug head 17.

Said elastic plug stem 19 has an axial extension A-A transverse to the radial extension R-R thereof which is less than the axial extension of said elastic plug foot 16 and said elastic plug head 17.

According to an embodiment, said elastic plug 9 has an annular elastic plug body 15.

In cross section to the annular extension thereof, it has an elastic plug foot 16 in contact with said tubular support element 5; an elastic plug head 17 radially externally forming an outer impact surface 18; an elastic plug stem 19 placed radially between said elastic plug foot 16 and said elastic plug head 17.

Said elastic plug foot 16 has an axial extension A-A transverse to the radial extension R-R thereof which is greater than the axial extension of said elastic plug head 17.

According to an embodiment, said elastic coating 7 comprises a first plurality of elastic plugs 9 placed side-by-side.

Each elastic plug 9 has an annular elastic plug body 15; where, in cross section to the annular extension thereof, it has an elastic plug foot 16 in contact with said tubular support element 5; an elastic plug head 17 radially externally forming an outer impact surface 18; an elastic plug stem 19 placed radially between said elastic plug foot 16 and said elastic plug head 17.

Moreover, a clearance is provided between one elastic plug head 17 and an elastic plug head 17 adjacent thereto.

Thereby, the stem is narrower and allows for radial elastic deformation and axial clearance for the axial elastic deformation.

According to an embodiment, said reinforced plug 11 has an annular reinforced plug body 20.

According to an embodiment, said reinforced plug 11 has an annular, single-piece reinforced plug body 20 made of elastic material, with the exception of the reinforcing ring 13 associated with said reinforced plug base 12.

According to an embodiment, said reinforced plug 11 has an annular, single-piece reinforced plug body 20 made of elastic material, with the exception of the reinforcing ring 13 incorporated in said reinforced plug base 12.

According to an embodiment, said reinforced plug 11 has an annular, single-piece elastic plug body 20 made of elastic material, with the exception of the reinforcing ring 13 made of metal material and associated with said reinforced plug base 12.

According to an embodiment, said reinforced plug 11 has an annular, single-piece reinforced plug body 20 made of elastic material, with the exception of the reinforcing ring 13 associated with said reinforced plug base 12, leaving a reinforced plug foot 21 between said reinforcing ring 13 and said inner tubular reinforced plug surface 14.

According to an embodiment, said reinforced plug 11 has an annular, single-piece reinforced plug body 20 made of elastic material, with the exception of the reinforcing ring 13 associated with said reinforced plug base 12, leaving a reinforced plug foot 21 between said reinforcing ring 13 and said inner tubular reinforced plug surface 14, so that when the reinforced plug 11 is fitted onto said tubular support element 5, the material of said reinforced plug foot 21 is substantially subject to circumferential stress, it being preloaded with a tension adapted to avoid a blow on said reinforced plug 11 by the falling material 8 from detaching the opposite side upon blowing said inner tubular reinforced plug surface 14 by said tubular element support surface 52 of the tubular support element.

According to an embodiment, said reinforced plug 11 has an annular reinforced plug body 20.

In cross section to the annular extension thereof, it has a reinforced plug foot 21 in contact with said tubular support element 5 as an inner part of said reinforced plug base 12; a reinforced plug head 22 radially externally forming an outer impact surface 23 of reinforced plug; a reinforced plug stem 24 placed radially between said reinforced plug base 12 and said reinforced plug head 22.

According to an embodiment, said reinforced plug 11 has an annular reinforced plug body 20.

In cross section to the annular extension thereof, it has a reinforced plug foot 21 in contact with said tubular support element 5 as an inner part of said reinforced plug base 12; a reinforced plug head 22 radially externally forming an outer impact surface 23 of reinforced plug; a reinforced plug stem 24 placed radially between said reinforced plug base 12 and said reinforced plug head 22.

Said reinforced plug stem 24 has an axial extension A-A transverse to the radial extension R-R thereof which is less than the axial extension A-A of said reinforced plug base 12 and said reinforced plug head 22.

According to an embodiment, said reinforced plug 11 has an annular reinforced plug body 20.

In cross section to the annular extension thereof, it has a reinforced plug foot 21 in contact with said tubular support element 5 as an inner part of said reinforced plug base 12; a reinforced plug head 22 radially externally forming an outer impact surface 23 of reinforced plug; a reinforced plug stem 24 placed radially between said reinforced plug base 12 and said reinforced plug head 22.

Said reinforced plug base 12 has an axial extension A-A transverse to the radial extension R-R thereof which is greater than the axial extension A-A of said reinforced plug head 22.

Thereby, the stem is axially narrower and allows for a radial elastic deformation and axial clearance for axial elastic deformation.

According to an embodiment, said elastic plug 9, when said inner tubular elastic plug surface 10 is fitted onto said tubular element support surface 52 of said tubular support element 5, is coupled by interference to said tubular element support surface 52. For example, said interference is between 7 and 11 mm.

According to an embodiment, said reinforced plug 11, when said inner tubular reinforced plug surface 14 is fitted onto said tubular element support surface 52 of said tubular support element 5, is coupled by interference to said tubular element support surface (52). For example, said interference is between 2 and 5 mm.

According to an embodiment, said reinforcing ring 13 is made of a material with a greater elongation resistance than the material of the reinforced plug 11.

According to an embodiment, said reinforcing ring 13 is made of steel.

According to an embodiment, said reinforcing ring 13 is made of spring steel.

According to an embodiment, said reinforced plug foot 21 is made of an elastic material which allows a deformation of said reinforced plug 11, bringing the inner tubular reinforced plug surface 14 thereof from a diameter dimension Ditr to Ds.

According to an embodiment, said reinforced plug foot 21 comprises expansion openings 27, for example, axial grooves, which facilitate the elastic deformation of the reinforced plug foot 21.

According to an embodiment, said impact roller 1 comprises a shaft 3 extending along a rotation axis X-X defining said axial direction A-A.

Said shaft 3 being adapted to support said impact roller 1 at a support structure 4.

According to an embodiment, said impact roller 1 comprises a shaft 3 extending along a rotation axis X-X defining said axial direction A-A.

Said impact roller 1 comprises at least one end support 6 connected to said tubular support element 5 and rotatably keyed onto a support structure 4.

According to an embodiment, said impact roller 1 comprises a shaft 3 extending along a rotation axis X-X defining said axial direction A-A.

Said impact roller 1 comprises at least one end support 6 connected to said tubular support element 5 and freely rotatably keyed onto said shaft 3 so as to allow said tubular support element 5 to rotate about said shaft 3 which is supported by a support structure 4.

According to an embodiment, said impact roller 1 comprises a shaft 3 extending along a rotation axis X-X defining said axial direction A-A.

Said impact roller 1 comprises at least one end support 6 connected to said tubular support element 5 and rotatably keyed onto a support structure 4.

A rolling bearing 25 is embedded between said shaft 3 and said end support 6.

According to an embodiment, said impact roller 1 comprises a shaft 3 extending along a rotation axis X-X defining said axial direction A-A.

Said impact roller 1 comprises at least one end support 6 connected to said tubular support element 5 and rotatably keyed onto a support structure 4; and where
a rolling bearing 25 separated from the environment outside the impact roller 1 by a sealing device 26 is embedded between said shaft 3 and said end support 6.

The present invention also relates to a material transport system 30 comprising at least one impact roller 1 as defined by any one of the embodiments described above.

According to an embodiment, said material transport system 30 comprises at least one conveyor belt 2 supported by at least one impact roller 1.

The present invention also relates to a method of assembling an impact roller 1, comprising the steps of:
providing a tubular support element 5 extending in an axial direction A-A and adapted to rotate about a rotation axis X-X; said tubular support element 5 comprises an outer tubular element skirt 57 delimiting a tubular element support surface 52 having a predefined support surface diameter Ds;
providing at least one elastic plug 9 elastically deformable at least in a radial direction R-R orthogonal to said axial direction A-A; said elastic plug 9 comprising an inner tubular elastic plug surface 10;
providing at least one reinforced plug 11 made of elastic material; where said reinforced plug 11 comprises a reinforced plug base 12; said reinforced plug base 12 comprises at least one annular reinforcing ring 13 made of a material other than the material of the reinforced plug 11; and where said reinforced plug 11 comprises an inner tubular reinforced plug surface 14;
providing an assembly tool 31 comprising a first tubular portion 32 having an outer diameter Deu of first tool portion and a second ramp portion 33 having an outer surface which switches from said outer diameter Deu of first tool portion to said support surface diameter Ds;
approaching said assembly tool 31 with its greater diameter equal to said support surface diameter Ds to said tubular support element 5;
fitting said at least one elastic plug 9 with play onto said first tubular portion 32;
pushing, for example, by means of a press 40, said elastic plug 9 along said second ramp portion 33 so as to deform said inner tubular elastic plug surface 10 to said support surface diameter Ds;
sliding, for example, by means of said press 40, said elastic plug 9 along said tubular support element 5 up to a desired position;
fitting said at least one reinforced plug 9 with play onto said first tubular portion 32;
pushing, for example, with a press 40, said reinforced plug 11 along said second ramp portion 33 so as to deform said inner tubular reinforced plug surface 14 to said support surface diameter Ds;
sliding, for example, with a press 40, said reinforced plug 9 along said tubular support element 5 up to a desired position.

According to an embodiment variant of the method, there are comprised the further steps of:
fitting a plurality of said at least one elastic plug 9 with play onto said first tubular portion 32;
pushing, for example, with a press 40, one at a time or simultaneously, said plurality of said at least one elastic plug 9 along said second ramp portion 33 so as to deform said inner tubular elastic plug surface 10 of each elastic plug 9 to said support surface diameter Ds;
sliding, for example, with a press 40, one at a time or simultaneously, said plurality of said at least one elastic plug 9 along said tubular support element 5 up to a desired position;
fitting said at least one reinforced plug 11 with play onto said first tubular portion 32;
pushing, for example, with a press 40, said reinforced plug 11 along said second ramp portion 33 so as to deform said inner tubular reinforced plug surface 14 to said support surface diameter Ds;
sliding, for example, with a press 40, said reinforced plug 9 along said tubular support element 5 up to resting against the outermost one of said plurality of said at least one elastic plug 9.

According to an embodiment variant of the method, there are comprised the further steps of:
carrying out a painting step before the step of fitting said at least one elastic plug 9 and said at least one reinforced plug 11.

### REFERENCE SIGNS

1 impact roller
2 conveyor belt
3 shaft
4 support structure for supporting the impact roller
5 tubular support element
6 end support
7 elastic coating
8 falling material
9 elastic plug
10 inner tubular elastic plug surface
11 reinforced plug
12 reinforced plug base
13 reinforcing ring
14 inner tubular reinforced plug surface
15 elastic plug body
16 elastic plug foot
17 elastic plug head
18 outer impact surface
19 elastic plug stem
20 reinforced plug body
21 reinforced plug foot
22 reinforced plug head
23 outer impact surface of reinforced plug
24 reinforced plug stem
25 rolling bearing
26 sealing device
27 expansion openings of reinforcing plug foot
30 material transport system
31 assembly tool
32 first tubular portion
33 second ramp portion
40 press pusher
52 tubular element support surface
53 tubular skirt end
54 central tubular skirt area
57 tubular skirt or outer tubular element skirt
Ds support surface diameter
Dite resting elastic plug inner diameter
Ditr resting reinforced plug inner diameter
Deu outer diameter of first tool portion

1. An impact roller for a conveyor belt, comprising:
a tubular support element extending in an axial direction and adapted to rotate about a rotation axis; said tubular support element comprises an outer tubular element skirt delimiting a tubular element support surface having a predefined support surface diameter;
said tubular support element externally supports an elastic coating adapted to receive impacts due to the fall of falling material against said impact roller;
wherein said elastic coating comprises at least one elastic plug elastically deformable in at least a radial direction orthogonal to said axial direction; said elastic plug comprising an inner tubular elastic plug surface;
wherein said elastic plug with said inner tubular elastic plug surface, is fitted onto said tubular element support surface of said tubular support element; and
wherein said inner tubular elastic plug surface, when the elastic plug is disassembled from said tubular support element and under unworn resting conditions, has, in a radial section thereof, a smaller elastic plug inner diameter than said predefined support surface diameter;
wherein said elastic coating comprises at least one reinforced plug made of elastic material; wherein said reinforced plug comprises a reinforced plug base; said reinforced plug base comprises at least one annular reinforcing ring made of a material other than the material of the reinforced plug; and wherein said reinforced plug comprises an inner tubular reinforced plug surface;
wherein said reinforced plug with said inner tubular reinforced plug surface, is fitted onto said tubular element support surface of said tubular support element; and
wherein said inner tubular reinforced plug surface, when the reinforced plug is disassembled from said tubular support element and under unworn resting conditions, has, in a radial section thereof, a smaller reinforced plug inner diameter than said predefined support surface diameter and a greater reinforced plug inner diameter than said elastic plug inner diameter.

2. An impact roller according to claim 1, wherein
said tubular support element comprises at least one tubular skirt end; and
wherein said reinforced plug proximate said tubular skirt end; or
wherein said tubular support element comprises two opposite tubular skirt ends; and
wherein a reinforced plug proximate each of said opposite tubular skirt ends; or
wherein said tubular support element comprises two opposite tubular skirt ends and a central tubular skirt area placed substantially equally spaced apart from said two opposite tubular skirt ends; and
wherein a reinforced plug proximate each of said opposite tubular skirt ends; and
wherein at least one reinforced plug is at said central tubular skirt area.

3. The impact roller according to claim 1, wherein
said elastic coating comprises a plurality of elastic plugs placed side-by-side; and
wherein two opposite reinforced plugs placed side-by-side are at ends of said plurality of elastic plugs; or
wherein said elastic coating comprises a plurality of adjacent elastic plugs in contact two-by-two, and
wherein two opposite reinforced plugs keeping said plurality of elastic plugs in contact are at the ends of said plurality of bundled elastic plugs.

4. The impact roller according to claim 1, wherein said elastic coating comprises a first plurality of elastic plugs placed side-by-side; and wherein two opposite reinforced plugs placed side-by-side are at ends of said first plurality of elastic plugs;
said elastic coating comprises a second plurality of elastic plugs placed side-by-side; and
wherein a first end of said second plurality of elastic plugs placed side-by-side is placed in contact with one of the reinforced plugs placed at the ends of said first plurality of elastic plugs; and
wherein a further reinforced plug is placed at an opposite end of said second plurality of elastic plugs.

5. The impact roller according to claim 1, wherein
said elastic plug has an annular elastic plug body; or
wherein said elastic plug has an annular, single-piece elastic plug body made of elastic material; or
wherein said elastic plug has an annular elastic plug body without annular inserts made of different material; or
wherein said elastic plug has an annular elastic plug body without annular inserts made of different material so that when the elastic plug is fitted onto said tubular support element, substantially all the material of said elastic plug body is subject to circumferential stress; or
wherein said elastic plug has an annular elastic plug body;
wherein, in cross section to the annular extension thereof, said elastic plug has an elastic plug foot in contact with said tubular support element; an elastic plug head radially externally forming an outer impact surface; an elastic plug stem placed radially between said elastic plug foot and said elastic plug head; or
wherein said elastic plug has an annular elastic plug body;
wherein, in cross section to the annular extension thereof, said elastic plug has an elastic plug foot in contact with said tubular support element; an elastic plug head radially externally forming an outer impact surface; an elastic plug stem placed radially between said elastic plug foot and said elastic plug head; and
wherein said elastic plug stem has an axial extension transverse to the radial extension thereof less than the axial extension of said elastic plug foot and said elastic plug head; or
wherein said elastic plug has an annular elastic plug body;
wherein, in cross section to the annular extension thereof, said elastic plug has an elastic plug foot in contact with said tubular support element; an elastic plug head radially externally forming an outer impact surface; an elastic plug stem placed radially between said elastic plug foot and said elastic plug head; and
wherein said elastic plug foot has an axial extension transverse to the radial extension thereof which is greater than the axial extension of said elastic plug head; or
wherein said elastic coating comprises a first plurality of elastic plugs placed side-by-side;
each elastic plug has an annular elastic plug body; wherein, in cross section to the annular extension thereof, said elastic plug has an elastic plug foot in contact with said tubular support element; an elastic plug head radially externally forming an outer impact surface; an elastic plug stem placed radially between said elastic plug foot and said elastic plug head; and
wherein a clearance is provided between one elastic plug head and an elastic plug head adjacent thereto.

6. The impact roller according to claim 1, wherein
said reinforced plug has an annular reinforced plug body; or
wherein said reinforced plug has an annular, single-piece reinforced plug body made of elastic material, with the exception of the reinforcing ring associated with said reinforced plug base; or
wherein said reinforced plug has an annular, single-piece reinforced plug body made of elastic material, with the exception of the reinforcing ring incorporated in said reinforced plug base; or
wherein said reinforced plug has an annular, single-piece elastic plug body made of elastic material, with the exception of the reinforcing ring made of metal material and associated with said reinforced plug base; or
wherein said reinforced plug has an annular, single-piece reinforced plug body made of elastic material, with the exception of the reinforcing ring associated with said reinforced plug base, leaving a reinforced plug foot between said reinforcing ring and said inner tubular reinforced plug surface; or
wherein said reinforced plug has an annular, single-piece reinforced plug body made of elastic material, with the exception of the reinforcing ring associated with said reinforced plug base, leaving a reinforced plug foot between said reinforcing ring and said inner tubular reinforced plug surface; so that when the reinforced plug is fitted onto said tubular support element, the material of said reinforced plug foot is substantially subject to circumferential stress, being preloaded with a tension adapted to avoid a blow on said reinforced plug by the falling material from detaching the opposite side upon blowing said inner tubular reinforced plug surface by said tubular element support surface of the tubular support element; or
wherein said reinforced plug has an annular reinforced plug body;
wherein, in cross section to the annular extension thereof, said reinforced plug has a reinforced plug foot in contact with said tubular support element as an inner part of said reinforced plug base; a reinforced plug head radially externally forming an outer impact surface of reinforced plug; a reinforced plug stem placed radially between said reinforced plug base and said reinforced plug head; or
wherein said reinforced plug has an annular reinforced plug body;
wherein, in cross section to the annular extension thereof, said reinforced plug has a reinforced plug foot in contact with said tubular support element as an inner part of said reinforced plug base; a reinforced plug head radially externally forming an outer impact surface of reinforced plug; a reinforced plug stem placed radially between said reinforced plug base and said reinforced plug head; and
wherein said reinforced plug stem has an axial extension transverse to the radial extension thereof less than the axial extension of said reinforced plug base and said reinforced plug head; or
wherein said reinforced plug has an annular reinforced plug body;
wherein, in cross section to the annular extension thereof, said reinforced plug has a reinforced plug foot in contact with said tubular support element as an inner part of said reinforced plug base; a reinforced plug head radially externally forming an outer impact surface of reinforced plug; a reinforced plug stem placed radially between said reinforced plug base and said reinforced plug head; and
wherein said reinforced plug base has an axial extension transverse to the radial extension thereof which is greater than the axial extension of said reinforced plug head.

7. The impact roller according to claim 1, wherein said elastic plug, when said inner tubular elastic plug surface is fitted onto said tubular element support surface of said tubular support element, is coupled by interference to said tubular element support surface; and
wherein said reinforced plug when said inner tubular reinforced plug surface is fitted onto said tubular element support surface of said tubular support element, is coupled by interference to said tubular element support surface.

8. The impact roller according to claim 1, wherein said reinforcing ring is made of a material with a greater elongation resistance than the material of the reinforced plug; or
wherein said reinforcing ring is made of steel; or
wherein said reinforcing ring is made of spring steel.

9. The impact roller according to claim 6, wherein said reinforced plug foot is made of an elastic material which allows a deformation of said reinforced plug bringing the inner tubular reinforced plug surface thereof from a diameter dimension smaller reinforced plug inner diameter to a diameter dimension of said predefined support surface diameter; or
wherein said reinforced plug foot comprises expansion openings, which facilitate the elastic deformation of the reinforced plug foot.

10. The impact roller according to claim 1, wherein said impact roller comprises a shaft extending along a rotation axis defining said axial direction; and
wherein said shaft is adapted to support said impact roller at a support structure; or
wherein said impact roller comprises a shaft extending along a rotation axis defining said axial direction; and
wherein said impact roller comprises at least one end support connected to said tubular support element and rotatably keyed onto a support structure; or
wherein said impact roller comprises a shaft extending along a rotation axis defining said axial direction; and
wherein said impact roller comprises at least one end support connected to said tubular support element and freely rotatably keyed onto said shaft to allow said tubular support element to rotate about said shaft which is supported by a support structure; or
wherein said impact roller comprises a shaft extending along a rotation axis (XX) defining said axial direction; and
wherein said impact roller comprises at least one end support connected to said tubular support element and rotatably keyed onto a support structure; and
wherein a rolling bearing is embedded between said shaft and said end support; or
wherein said impact roller comprises a shaft extending along a rotation axis defining said axial direction; and
wherein said impact roller comprises at least one end support connected to said tubular support element and rotatably keyed onto a support structure; and
wherein a rolling bearing separated from the environment outside the impact roller by a sealing device is embedded between said shaft and said end support.

11. A material transport system comprising at least one impact roller according to claim 1.

12. The material transport system according to claim 11, wherein said material transport system comprises at least one conveyor belt supported by at least one impact roller.

13. A method of assembling an impact roller comprising the steps of:
providing a tubular support element extending in an axial direction and adapted to rotate about a rotation axis; said tubular support element comprises an outer tubular element skirt delimiting a tubular element support surface having a predefined support surface diameter;
providing at least one elastic plug elastically deformable at least in a radial direction orthogonal to said axial direction; said elastic plug comprising an inner tubular elastic plug surface which, under unworn resting conditions, has, in a radial section thereof, a smaller elastic plug inner diameter than said predefined support surface diameter;
providing at least one reinforced plug made of elastic material; wherein said reinforced plug comprises a reinforced plug base; said reinforced plug base comprises at least one annular reinforcing ring made of a material other than the material of the reinforced plug; and wherein said reinforced plug comprises an inner tubular reinforced plug surface which, under unworn resting conditions, has, in a radial section thereof, a smaller reinforced plug inner diameter than said predefined support surface diameter and a greater reinforced plug inner diameter than said elastic plug inner diameter;
providing an assembly tool comprising a first tubular portion having an outer diameter of first tool portion and a second ramp portion having an outer surface which switches from said outer diameter of first tool portion to said support surface diameter;
approaching said assembly tool with a maximum diameter equal to said support surface diameter to said tubular support element;
fitting said at least one elastic plug with play onto said first tubular portion;
pushing said elastic plug along said second ramp portion to deform said inner tubular elastic plug surface to said support surface diameter;
sliding said elastic plug along said tubular support element up to a desired position;
fitting said at least one reinforced plug with play onto said first tubular portion;
pushing said reinforced plug along said second ramp portion to deform said inner tubular reinforced plug surface to said support surface diameter;
sliding said reinforced plug along said tubular support element up to a desired position.

14. The method of assembling an impact roller according to claim 13, comprising the further steps of:
fitting a plurality of said at least one elastic plug with play onto said first tubular portion;
pushing, one at a time or simultaneously, said plurality of said at least one elastic plug along said second ramp portion to deform said inner tubular elastic plug surface of each elastic plug to said support surface diameter;
sliding, one at a time or simultaneously, said plurality of said at least one elastic plug along said tubular support element up to a desired position;
fitting said at least one reinforced plug with play onto said first tubular portion;
pushing said reinforced plug along said second ramp portion to deform said inner tubular reinforced plug surface to said support surface diameter;
sliding said reinforced plug along said tubular support element up to resting against the outermost one of said plurality of said at least one elastic plug.

15. The method of assembling an impact roller according to claim 13, comprising the further steps of:
carrying out a painting step before the step of fitting said at least one elastic plug and said at least one reinforced plug.

16. The impact roller according to claim 1, wherein
said elastic plug, when said inner tubular elastic plug surface is fitted onto said tubular element support surface of said tubular support element, is coupled by interference to said tubular element support surface; wherein said interference is between 7 and 11 mm; and
wherein said reinforced plug, when said inner tubular reinforced plug surface is fitted onto said tubular element support surface of said tubular support element, is coupled by interference to said tubular element support surface; wherein said interference is between 2 and 5 mm.

17. The impact roller according to claim 9, wherein said expansion openings comprise axial grooves.

18. The impact roller according to claim 1, wherein
said elastic coating comprises a plurality of elastic plugs placed side-by-side; and
wherein two opposite reinforced plugs placed side-by-side are at ends of said plurality of elastic plugs; or
wherein said elastic coating comprises a plurality of adjacent elastic plugs bundled two-by-two; and
wherein two opposite reinforced plugs keeping said plurality of elastic plugs bundled are at the ends of said plurality of bundled elastic plugs.
